(19) United States
(12) Patent Application Publication
(10) Pub. No.: US 2026/0187820 A1
(43) Pub. Date: Jul. 2, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventors: Hiroshi FUKUI, Tokyo (JP); Akinori EBIHARA, Tokyo (JP); Taiki MIYAGAWA, Tokyo (JP)

(73) Assignee: NEC Corporation, Tokyo (JP)

(21) Appl. No.: 19/130,225

(22) PCT Filed: Nov. 25, 2022
(86) PCT No.: PCT/JP2022/043535

§ 371 Date: May 15, 2025

(51) Int. Cl. G06T 7/246

(52) U.S. Cl. CPC G06T 7/248; G06T 2207/10016; G06T 2207/20076; G06T 2207/20084; G06T 2207/30196

(57) ABSTRACT

An information processing apparatus includes: a determination unit that determines whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data; and a selection unit that selects the second element as a new criterion for the correspondence between the two elements when it is determined that the certainty factor is higher than the predetermined threshold, and that selects the first element as the criterion for the correspondence between the two elements when it is determined that the certainty factor is lower than the predetermined threshold.

### TECHNICAL FIELD

The present disclosure relates to technical fields of an information processing apparatus, an information processing method, and a recording medium.

### BACKGROUND ART

For example, there is proposed an apparatus that tracks a specific object from images taken at a plurality of times, and that tracks a tracking target while simultaneously tracking an object similar to the tracking target (see Patent Literature 1). Furthermore, prior art documents related to the present disclosure include Patent Literatures 2 to 7.

### CITATION LIST

### Patent Literature

Patent Literature 1: WO2022/019076A1

Patent Literature 2: WO 2021/130951A1

Patent Literature 3: WO 2020/194497A1

Patent Literature 4: JP2022-030852A

Patent Literature 5: JP2022-019339A

Patent Literature 6: JP2020-016901A

Patent Literature 7: JP2018-077807

### SUMMARY

### Technical Problem

It is an example object of the present disclosure to provide an information processing apparatus, an information processing method, and a recording medium that aim to improve the techniques/technologies disclosed in Citation List.

### Solution to Problem

An information processing apparatus according to an example aspect includes: a determination unit that determines whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data; and a selection unit that selects the second element as a new criterion for the correspondence between the two elements when it is determined that the certainty factor is higher than the predetermined threshold, and that selects the first element as the criterion for the correspondence between the two elements when it is determined that the certainty factor is lower than the predetermined threshold.

An information processing method according to an example aspect includes: determining whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data; selecting the second element as a new criterion for the correspondence between the two elements when it is determined that the certainty factor is higher than the predetermined threshold; and selecting the first element as the criterion for the correspondence between the two elements when it is determined that the certainty factor is lower than the predetermined threshold.

A recording medium according to an example is a recording medium on which a computer program that allows a computer to execute an information processing method is recorded, the information processing method including: determining whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data; selecting the second element as a new criterion for the correspondence between the two elements when it is determined that the certainty factor is higher than the predetermined threshold; and selecting the first element as the criterion for the correspondence between the two elements when it is determined that the certainty factor is lower than the predetermined threshold.

### BRIEF DESCRIPTION OF DRAWINGS

FIG. 1 is a block diagram illustrating an example of a configuration of an information processing apparatus.

FIG. 2 is a block diagram illustrating another example of the configuration of the information processing apparatus.

FIG. 3 is a diagram illustrating an example of a frame included in video data.

FIG. 4 is a block diagram illustrating a configuration of an object verification unit.

FIG. 5 is a flowchart illustrating an object verification operation according to a second example embodiment.

FIG. 6 is a diagram illustrating an example of an affinity matrix.

FIG. 7 is a block diagram illustrating a configuration of a refining unit.

FIG. 8 is a flowchart illustrating a refining operation according to the second example embodiment.

FIG. 9 is a diagram illustrating an example of a time change in a state of an object as a tracking target.

FIG. 10 is a block diagram illustrating another example of the configuration of the information processing apparatus.

FIG. 11 is a block diagram illustrating another example of the configuration of the information processing apparatus.

FIG. 12 is a diagram illustrating an example of a face authentication gate apparatus.

FIG. 13 is a diagram illustrating an example of an ID correspondence table.

### DESCRIPTION OF EXAMPLE EMBODIMENTS

An information processing apparatus, an information processing method, and a recording medium according to example embodiments will be described.

### First Example Embodiment

An information processing apparatus, an information processing method, and a recording medium according to a first example embodiment will be described with reference to FIG. 1. The following describes the information processing apparatus, the information processing method, and the recording medium according to the first example embodiment, by using an information processing apparatus 1.

In FIG. 1, the information processing apparatus 1 includes a determination unit 11 and a selection unit 12. The determination unit 11 determines whether or not a certainty factor is higher than a predetermined threshold, in a case of obtaining a correspondence between a first element and a second element, by using the first element as a criterion for a correspondence between two elements, wherein the first element is acquired at a first time, and the second element is acquired at a second time after the first time, and the first and second elements are included in time-series data. The certainty factor may be calculated by using a score for determining whether or not the second element corresponds to the first element. The time-series data mean data strings that may be acquired in chronological order and that may be decomposed into a plurality of elements. Specific examples of the time-series data include video data, a plurality of images of a same object or location captured at regular or irregular intervals, and audio/sound data. In a case where the time-series data are video data, a plurality of elements included in the time-series data may be a plurality of frames that constitute a video/moving image, or may indicate an object included in each of the frames.

The elements included in the time-series data may change over time. For example, in a case where the element is the object included in each of the plurality of frames that constitute the video, at least one of a position and a state of the object may change over time. In a case of associating the elements that change over time with each other, it may be determined whether or not the second element corresponds to the first element, by using the first element of the two elements as a criterion, wherein the first element is temporally earlier than the second element, and the second element is temporally later than the first element. When it is determined that the second element corresponds to the first element, it may be determined whether or not a third element corresponds to the second element, by using the second element as a new criterion, wherein the third element is temporally later than the second element. On the other hand, when it is determined that the second element does not correspond to the first element, it is considered that there is no element corresponding to the first element, and the association of the first element with another element is often ended. By the way, elements may temporarily change irregularly. Due to such a temporary irregular change, it may be determined that the second element does not correspond to the first element. In this case, if the association of the first element with another element is ended, there is a possibility that the elements may not be properly associated with each other.

When it is determined by the determination unit 11 that the certainty factor is higher than the predetermined threshold (specifically, when, based on the score for determining whether or not the second element corresponds to the first element, the second element corresponds to the first element and the certainty factor is higher than the predetermined threshold), the selection unit 12 selects the second element as a new criterion for the correspondence relation between the two elements. On the other hand, when it is determined by the determination unit 11 that the certainty factor is lower than the predetermined threshold (specifically, when, based on the score for determining whether or not the second element corresponds to the first element, the second element corresponds to the first element, but the certainty factor is lower than the predetermined threshold), the selection unit 12 selects the first element as a criterion for the correspondence relation between the two elements (i.e., maintains a criterion for the correspondence relation between the two elements). In this case, the correspondence relation between the first element and the third element that is temporally later than the second element, may be obtained. In this configuration, it is possible to reduce an influence of the temporary irregular change on the association of the elements. Therefore, according to the information processing apparatus 1, it is possible to properly associate the elements with each other. Furthermore, when the certainty factor is equal to the predetermined threshold, it may be treated as either case.

In the information processing apparatus 1, the determination unit 11 may determine whether or not the certainty factor is higher than the predetermined threshold, in a case of obtaining the correspondence between the first element and the second element, by using the first element as a criterion for the correspondence between two elements, wherein the first element is acquired at the first time, and the second element is acquired at the second time after the first time, and the first and second elements are included in the time-series data. The certainty factor may be calculated by using the score for determining whether or not the second element corresponds to the first element. When the certainty factor is determined to be higher than the predetermined threshold, the selection unit 12 may select the second element as a new criterion for the correspondence relation between the two elements. When the certainty factor is determined to be lower than the predetermined threshold, the selection unit 12 may select the first element as a criterion for the correspondence relation between the two elements.

Such an information processing apparatus 1 may be realized, for example, by a computer reading a computer program recorded on a recording medium. In this case, it can be said that a computer program that allows a computer to execute an information processing method is recorded on a recording medium, the information processing method including: determining whether or not a certainty factor is higher than a predetermined threshold, in a case of obtaining a correspondence between a first element and a second element, by using the first element as a criterion for a correspondence between two elements, the first element being acquired at a first time, the second element being acquired at a second time after the first time, and the first and second elements being included in time-series data; selecting the second element as a new criterion for the correspondence between the two elements when it is determined that the certainty factor is higher than the predetermined threshold; and selecting the first element as the criterion for the correspondence between the two elements when it is determined that the certainty factor is lower than the predetermined threshold.

The information processing apparatus 1 may be realized by a server apparatus (e.g., a cloud server), or may be realized by a terminal apparatus (e.g., at least one of a smartphone, a tablet terminal, and a notebook-type personal computer).

### Second Example Embodiment

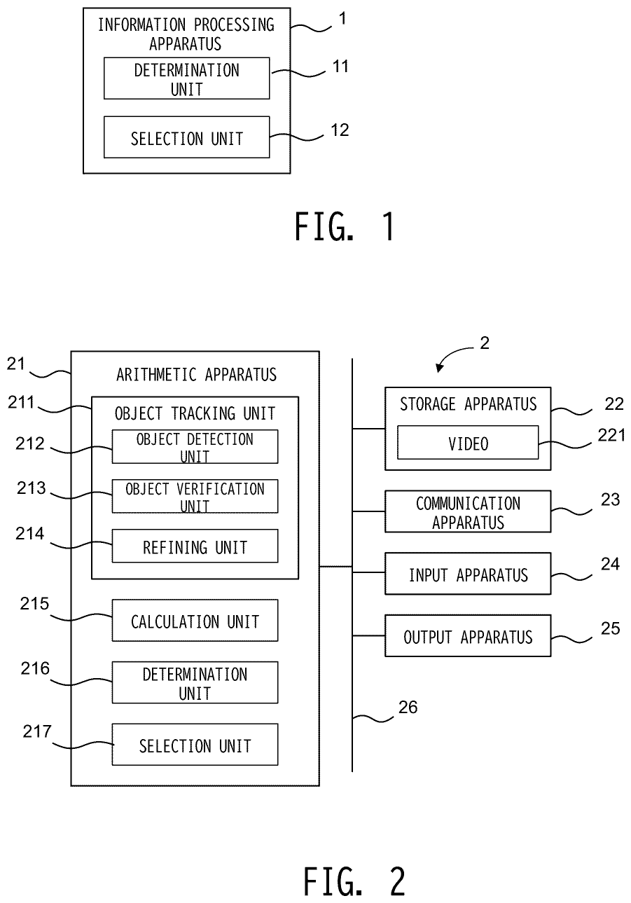

An information processing apparatus, an information processing method, and a recording medium according to a second example embodiment will be described with reference to FIG. 2 to FIG. 9. The following describes the information processing apparatus, the information processing method, and the recording medium according to the second example embodiment, by using an information processing apparatus 2.

### (1) Configuration of Information Processing Apparatus 2

As illustrated in FIG. 2, the information processing apparatus 2 includes an arithmetic apparatus 21, a storage apparatus 22, and a communication apparatus 23. The information processing apparatus 2 may include an input apparatus 24 and an output apparatus 25. Furthermore, the information processing apparatus 2 may not include at least one of the input apparatus 24 and the output apparatus 25. In the information processing apparatus 2, the arithmetic apparatus 21, the storage apparatus 22, the communication apparatus 23, the input apparatus 24, and the output apparatus 25 may be connected via a data bus 26.

The arithmetic apparatus 21 may include, for example, at least one of a CPU (Central Processing Unit), a GPU (Graphics Processing Unit), an FPGA (Field Programmable Gate Array), a TPU (Tensor Processing Unit), and a quantum processor.

The storage apparatus 22 may include, for example, at least one of a RAM (Random Access Memory), a ROM (Read Only Memory), a hard disk apparatus, a magneto-optical disk apparatus, a SSD (Solid State Drive), and an optical disk array. That is, the storage apparatus 22 may include a non-transitory recording medium. The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may include video data 221. The video data 221 corresponds to an example of the “time-series data” in the first example embodiment described above.

The communication apparatus 23 may be configured to communicate with an apparatus external to the information processing apparatus 2 via a not-illustrated communication network. The communication apparatus 23 may perform wired communication or wireless communication.

The input apparatus 24 is an apparatus that is configured to receive an input of information to the information processing apparatus 2 from the outside. The input apparatus 24 may include an operating apparatus (e.g., a keyboard, mouse, touch panel, etc.) that is operable by an operator of the information processing apparatus 2. The input apparatus 24 may include a recording medium reading apparatus that is configured to read information recorded on a recording medium that is attachable to or detachable from the information processing apparatus 2, such as a USB (Universal Serial Bus) memory. When information is inputted to the information processing apparatus 2 via the communication apparatus 23 (in other words, when the information processing apparatus 2 acquires information via the communication apparatus 23), the communication apparatus 23 may function as an input apparatus.

The output apparatus 25 is an apparatus that is configured to output information to the outside of the information processing apparatus 2. The output apparatus 25 may output visual information such as characters and an image, may output auditory information such as a voice/sound, or may output tactile information such as vibration, as the information described above. The output apparatus 25 may include, for example, at least one of a display, a speaker, a printer, and a vibration motor. The output apparatus 25 may be configured to output information to a recording medium that is attachable to or detachable from the information processing apparatus 2, such as, for example, a USB memory. When the information processing apparatus 2 outputs information via the communication apparatus 23, the communication apparatus 23 may function as an output apparatus.

The arithmetic apparatus 21 may include an object tracking unit 211, a calculation unit 215, a determination unit 216, and a selection unit 217, as functional blocks that are logically realized, or as processing circuits that are physically realized. The object tracking unit 211 may include an object detection unit 212, an object verification unit 213, and a refining unit 214. At least one of the object tracking unit 211, the calculation unit 215, the determination unit 216, and the selection unit 217 may be realized in mixed forms of the logical functional blocks and the physical processing circuits (i.e., hardware). When at least a part of the object tracking unit 211, the calculation unit 215, the determination unit 216, and the selection unit 217 is the functional block, at least the part of the object tracking unit 211, the calculation unit 215, the determination unit 216, and the selection unit 217 may be realized by the arithmetic apparatus 21 executing a predetermined computer program.

The arithmetic apparatus 21 may acquire (in other words, may read) the predetermined computer program, from the storage apparatus 22. The arithmetic apparatus 21 may read the predetermined computer program stored on a computer-readable and non-transitory recording medium, by using a not-illustrated recording medium reading apparatus provided in the information processing apparatus 2. The arithmetic apparatus 21 may acquire (in other words, may downloaded or may read) the predetermined computer program from a not-illustrated apparatus disposed outside the information processing apparatus 2 via the communication apparatus 23. For the recording medium on which the predetermined computer program to be executed by the arithmetic apparatus 21 is recorded, at least one of an optical disk, a magnetic medium, a magneto-optical disk, a semiconductor memory, and any other medium that is configured to store a program may be used.

### (2) Object Tracking Operation Performed by Object Tracking Unit 211

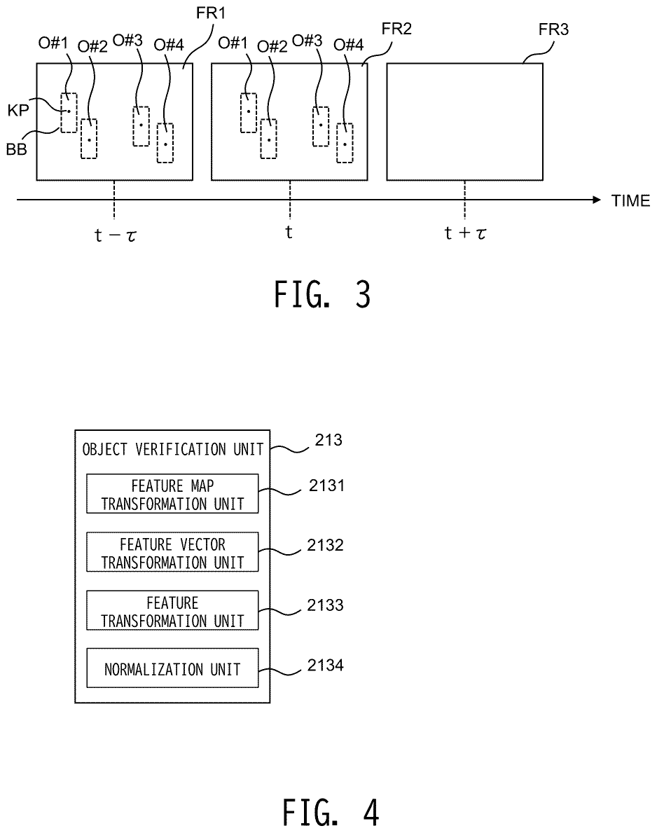

An object tracking operation performed by the object tracking unit 211 will be described. The object tracking operation may include an object detection operation, an object verification operation, and a refining operation. Hereinafter, the object detection operation, the object verification operation, and the refining operation will be described in order. The video data 221 included in the storage apparatus 22 may include frames FR1, FR2, and FR3, as illustrated in FIG. 3. The frame FRI is a frame captured at a time t−τ. The frame FR2 is a frame captured at a time t. The frame FR3 is a frame captured at a time t+τ. The term “τ” is a time corresponding to an image capture cycle. Since the object tracking unit 211 performs the object tracking operation, it may also be referred to as a tracking unit.

### (2-1) Object Detection Operation

An object detection operation performed by the object detection unit 212 will be described. The object detection unit 212 reads out the frame (e.g., at least one of the frames FR1, FR2, and FR3) included in the video data 221, and performs the object detection operation on the read frame. The object detection unit 212 may detect an object O included in the frame (in other words, the object O captured in the frame), by using an existing method for detecting the object O included in the frame. It is, however, preferable that the object detection unit 212 performs the object detection operation, by using a method that allows acquisition of information about a position of the object O in the frame (hereinafter referred to as “object position information PI”) by detecting the object O in the frame. Since the object position information PI acquired by the object detection unit 212 indicates a result of the object detection operation by the object detection unit 212, it may be referred to as object detection information. In the following description, it is assumed that the object detection unit 212 detects the object O by using the method that allows the acquisition of the object position information PI.

The object detection unit 212 generates a heat map (a so-called score map) indicating a key point KP of the object O in the frame (see FIG. 3), as the object position information PI. More specifically, the object detection unit 212 generates a heat map indicating the key point KP of the object O in the frame, for each object O. Since the heat map indicating the key point KP is a map relating to position, it may also be referred to as a position map.

The object detection unit 212 may generate information indicating, in the form of a score map, a size of a bounding box BB of the object O (see FIG. 3), as the object position information PI. The information indicating the size of the bounding box BB of the object O may be considered to be substantially information indicating a size of the object O. Since this map information indicating the size of the bounding box BB is also a map relating to position, it may also be referred to as a position map.

The object detection unit 212 may generate information indicating, in the form of a score map, a local offset of the bounding box BB of the object O, as the object position information PI. Since this map information indicating the local offset of the bounding box BB is also a map relating to position, it may also be referred to as a position map.

The frame FR1 captured at the time t−τ includes four objects O_{t-τ}#1, O_{t-τ}#2, O_{t-τ}#3, and O _{t-τ}#4. In this case, the object detection unit 212 may generate, as object position information PI_{t-τ}, at least one of: information indicating the key point KP of each of the four objects O_{t-τ}#1, O_{t-≢}#2, O_{t-τ}#3, and O_{t-τ}#4; the information indicating the size of the bounding box BB; and the information indicating the local offset of the bounding box BB.

The frame FR2 captured at the time t includes four objects Oₜ#1, Oₜ#2, Oₜ#3, and Oₜ#4. In this case, the object detection unit 212 may generate, as object position information PIₜ, at least one of: information indicating the key point KP of each of the four objects Oₜ#1, Oₜ#2, Oₜ#3, and Oₜ#4; the information indicating the size of the bounding box BB; and the information indicating the local offset of the bounding box BB.

The object detection unit 212 may perform the object detection operation, by using an arithmetic model that outputs the object position information PI when the frame is inputted. An example of such an arithmetic model is an arithmetic model using a neural network (e.g., a convolutional neural network (CNN)). A parameter of the arithmetic model may be optimized to output appropriate object position information PI. In this case, the parameter of the arithmetic model may be updated based on a loss function relating to the object position information PI (e.g., at least one of the object position information PI_{t-τ} and the object position information PIₜ) acquired by the object detection unit 212. The object detection unit 212 may calculate a loss of the object position information PI, based on the loss function.

### (2-2) Object Verification Operation

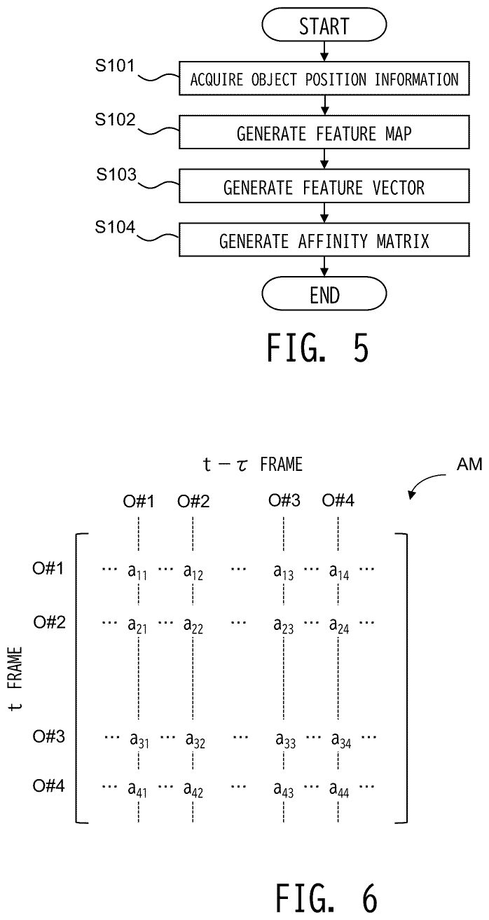

The object verification operation performed by the object verification unit 213 will be described with reference to FIG. 4 and FIG. 5. The object verification unit 213 reads the object position information PI acquired by the object detection unit 212, and performs the object verification operation by using the read object position information PI. As illustrated in FIG. 4, the object verification unit 213 includes a feature map transformation unit 2131, a feature vector transformation unit 2132, a feature transformation unit 2133, and a normalization unit 2134.

The following describes the object verification operation of collating/verifying the four objects O_{t-τ}#1, O_{t-τ}#2, O_{t-τ}#3, and O_{t-τ}#4 included in the frame FR1 with the four objects Ot #1, Ot #2, Oₜ#3, and Oₜ#4 included in the frame FR2. Hereinafter, the four objects O_{t-τ}#1, O_{t-τ}#2, O_{t-τ}#3, and O_{t-τ}#4 included in the frame FR1 will be referred to as an “object Ot-t” as appropriate. Furthermore, the four objects Oₜ#1, Oₜ#2, Oₜ#3, and Oₜ#4 included in the frame FR2 will be referred to as an “object Oₜ” as appropriate.

In a flowchart in FIG. 5, the feature map transformation unit 2131 may acquire the object position information PI_{t-τ} about the object O_{t-τ} (i.e., the four objects O_{t-τ}#1, O_{t-τ}#2, O_{t-τ}#3, and O_{t-τ}#4) included in the frame FR1 (step S101). The feature map transformation unit 2131 may generate a feature map CM_{t-τ} from the object position information PI_{t-τ} (step S102). The feature map transformation unit 2131 may acquire the object position information PIₜ about the object Oₜ (i.e., the four objects Oₜ#1, Oₜ#2, Oₜ#3, and Oₜ#4) included in the frame FR2 (step S101). The feature map transformation unit 2131 may generate a feature map CMₜ from the object position information PIₜ (step S102). A feature map CM (e.g., the feature maps CM_{t-τ} and CMₜ) is a feature map indicating a feature quantity of the object position information PI (e.g., the object position information PI_{t-τ} and PIₜ), for each arbitrary channel.

The feature map transformation unit 2131 may generate the feature map CM by using an arithmetic model that outputs the feature map CM when the object position information PI is inputted. An example of such an arithmetic model is an arithmetic model using a neural network (e.g., CNN). A parameter of the arithmetic model may be optimized to output an appropriate feature map CM (in particular, a feature map CM suitable for generating an affinity matrix AM described later).

In the flowchart in FIG. 5, after the step S102, the feature vector transformation unit 2132 may generate a feature vector CV_{t-τ} from the feature map CM_{t-τ} (step S103). The feature vector transformation unit 2132 may generate a feature vector CVₜ from the feature map CMₜ (step S103). The object verification unit 213 may directly generate a feature vector CV from the object position information PI without generating the feature map CM. Since the feature vector transformation unit 2132 generates the feature vector CV, it may be referred to as a first generation unit.

In the flowchart in FIG. 5, after the step S103, the feature transformation unit 2133 may generate an affinity matrix AM by using the feature vectors CV_{t-τ} and CVₜ (step S104). In the step S104, the feature transformation unit 2133 may generate the affinity matrix AM by using an arithmetic model that outputs the affinity matrix AM when the feature vectors CV_{t-τ} and CVₜ are inputted. An example of such an arithmetic model is an arithmetic model using a neural network (e.g., CNN).

In the step S104, the normalization unit 2134 normalizes the affinity matrix AM. The normalization unit 2134 may normalize the affinity matrix AM by normalizing the matrix product of the feature vector CVₜ and the feature vector CV_{t-τ}. The normalization unit 2134 may perform any normalization processing on the affinity matrix AM, such as normalization processing using at least one of a sigmoid function and a softmax function.

A case where the normalization unit 2134 performs the normalization processing using the softmax function on the affinity matrix AM, will be specifically described. The normalization unit 2134 may perform the normalization processing using the softmax function on row vector components, which are a plurality of components of each row of the affinity matrix AM, such that the sum total of the row vector components is 1. The normalization unit 2134 may perform the normalization processing using the softmax function on column vector components, which are a plurality of components of each column of the affinity matrix AM, such that the sum total of the column vector components is 1. The normalization unit 2134 may define a matrix including components obtained by multiplying the normalized row vector components and the normalized column vector components, as the normalized affinity matrix AM.

Let the vector components of the feature vector CVₜ be (x₁, x₂, ..., xₙ), and the vector components of the feature vector CV_{t-τ} be (y₁, y₂, ..., yₙ). In this case, the components of a first row of the affinity matrix AM, which is obtained by arithmetic processing of calculating the Hadamard product of the feature vectors CVₜ and CV_{t-τ}, may be (x₁*y₁, x₁*y₂, ... x₁*yₙ). The components of a second row of the affinity matrix AM may be (x₂*y₁, x₂*y₂, ... x₂*yₙ). The components of an n-th row of the affinity matrix AM may be (xₙ*y₁, xₙ*y₂, ... xₙ*yₙ). Here, the mark “*” indicates element-wise product by the Hadamard product.

Therefore, the components of each row of the affinity matrix AM may be the element-wise product of a certain vector component of the feature vector CVₜ and each vector component of the feature vector CV_{t-τ}. Thus, it can be said that a vertical axis of the affinity matrix AM corresponds to the vector components of the feature vector CVₜ. That is, it can be said that the vertical axis of the affinity matrix AM corresponds to a detection result of the object Oₜ (e.g. a position of the object Oₜ) included in the frame FR2 at the time t. The components of each column of the affinity matrix AM may be the element-wise product of a certain vector component of the feature vector CV_{t-τ} and each vector component of the feature vector CVₜ. Therefore, it can be said that a horizontal axis of the affinity matrix AM corresponds to the vector components of the feature vector CV_{t-τ}. That is, it can be said that the horizontal axis of the affinity matrix AM corresponds to a detection result of the object O_{t-τ} (e.g. a position of the object O_{t-τ}) included in the frame FR1 at the time t−τ.

The feature transformation unit 2133 may generate, as the affinity matrix AM, features obtained by the convolution neural network (CNN) and the element-wise product of the feature vector CV_{t-τ} and the feature vector CVₜ. In this case, the component of each row of the affinity matrix AM may be the product of a certain vector component of the feature vector CV_{t-τ} and each vector component of the feature vector CVₜ. Therefore, it can be said that the vertical axis of the affinity matrix AM corresponds to the vector components of the feature vector CV_{t-τ}. That is, it can be said that the vertical axis of the affinity matrix AM corresponds to a detection result of the object O_{t-τ} (e.g. a position of the object O_{t-τ}) included in the frame FR1 at the time t−τ. The components of each column of the affinity matrix AM may be the product of a certain vector component of the feature vector CVₜ and each vector component of the feature vector CV_{t-τ}. Therefore, it can be said that the horizontal axis of the affinity matrix AM corresponds to the vector components of the feature vector CVₜ. That is, it can be said that the horizontal axis of the affinity matrix AM corresponds to a detection result of the object Oₜ (e.g. a position of the object Oₜ) included in the frame FR2 at the time t.

At a position where the vector components corresponding to a certain object Oₜ on the vertical axis intersect with the vector components corresponding to a certain object O_{t-τ} on the horizontal axis, the components of the affinity matrix AM react (e.g., have values other than 0). In other words, the components of the affinity matrix AM react at the position where the detection result of the object Oₜ on the vertical axis intersects with the detection result of the object O_{t-τ} on the horizontal axis. That is, the affinity matrix AM may be a matrix in which the values of the components at the position where the vector components corresponding to the certain object Oₜ included in the feature vector CVₜ intersect with the vector component corresponding to the certain object O_{t-τ} included in the feature vector CV_{t-τ} are values obtained by multiplying both the vector components (e.g., values other than 0), whereas values of the other components are 0.

In the affinity matrix AM illustrated in FIG. 6, let the components of the affinity matrix AM be a₁₁, a₁₂, a₁₃, and a₁₄, at the positions where the vector components corresponding to the object Oₜ#1 included in the feature vector CVₜ intersect with the vector components corresponding to the objects Oₜ#1, Oₜ#2, Oₜ#3, and Oₜ#4 included in the feature vector CV_{t-τ}, respectively.

In the affinity matrix AM, let the components of the affinity matrix AM be a₂₁, a₂₂, a₂₃, and a₂₄, at the positions where the vector components corresponding to the object Oₜ#2 included in the feature vector CVₜ intersect with the vector components corresponding to the objects Oₜ#1, Oₜ#2, Oₜ#3, and Oₜ#4 included in the feature vector CV_{t-τ}, respectively.

In the affinity matrix AM, let the components of the affinity matrix AM be a₃₁, a₃₂, a₃₃, and a₃₄, at the positions where the vector components corresponding to the object Oₜ#3 included in the feature vector CVₜ intersect with the vector components corresponding to the objects Oₜ#1, Oₜ#2, Oₜ#3, and Oₜ#4 included in the feature vector CV_{t-τ}, respectively.

In the affinity matrix AM, let the components of the affinity matrix AM be a₄₁, a₄₂, a₄₃, and a₄₄, at the positions where the vector components corresponding to the object Oₜ#4 included in the feature vector CVₜ intersect with the vector components corresponding to the objects Oₜ#1, Oₜ#2, Oₜ#3, and Oₜ#4 included in the feature vector CV_{t-τ}, respectively.

In the affinity matrix AM, the components react (e.g., have values other than 0) at the positions where the vector components corresponding to the certain object Oₜ in the feature vector CVₜ intersect with the vector components corresponding to the certain object O_{t-τ} in the feature vector CV_{t-τ}. Therefore, the affinity matrix AM is usable as information indicating a correspondence relation between the object Oₜ and the object O_{t-τ}. That is, the affinity matrix AM is usable as information indicating a verification result between the object Oₜ included in the frame FR2 and the object O_{t-τ} included in the frame FR1. The affinity matrix AM is usable as information for tracking the position in the frame FR2 of the object O_{t-τ} included in the frame FR1. Since the affinity matrix AM is information indicating the correspondence relation between the object Oₜ and the object O_{t-τ}, it may also be referred to as correspondence information. Since the feature transformation unit 2133 generates the affinity matrix AM that may be referred to as the correspondence information, it may be referred to as a second generation unit.

### (2-3) Refining Operation

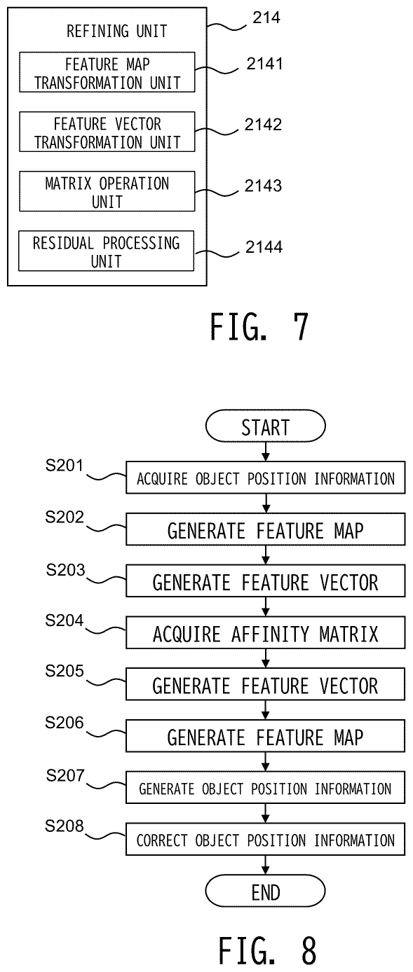

The refining operation performed by the refining unit 214 will be described with reference to FIG. 7 and FIG. 8. The refining operation is an operation for correcting the object position information PI acquired by the object detection unit 212. In FIG. 7, the refining unit 214 includes a feature map transformation unit 2141, a feature vector transformation unit 2142, a matrix operation unit 2143, and a residual processing unit 2144. Since the refining unit 214 performs the refining operation for correcting the object position information PI, it may be referred to as a correction unit.

In a flowchart in FIG. 8, the feature map transformation unit 2141 may acquire the object position information PI_{t-τ} about the object O_{t-τ} (i.e., the four objects O_{t-τ}#1, O_{t-τ}#2, O_{t-τ}#3, and O_{t-τ}#4) included in the frame FR1 (step S201). The feature map transformation unit 2141 may generate a feature map CM′_{t-τ} from the object position information PI_{t-τ} (step S202). The feature map transformation unit 2141 may acquire the object position information PIₜ about the object Oₜ (i.e., the four objects Oₜ#1, Oₜ#2, Oₜ#3, and Oₜ#4) included in the frame FR2 (step S201). The feature map transformation unit 2141 may generate a feature map CM′ₜ from the object position information PIₜ (step S202).

The feature map transformation unit 2141 of the refining unit 214 and the feature map transformation unit 2131 of the object verification unit 213 are common in that they generate the feature map (e.g., the feature map CM or CM′) from the object position information PI (e.g., the object position information PI_{t-τ} and PIₜ). However, the feature map transformation unit 2131 of the object verification unit 213 generates the feature map CM for the purpose of generating the affinity matrix AM (i.e., for the purpose of performing the object verification operation). In contrast, the feature map transformation unit 2141 of the refining unit 214 generates a feature map CM′ for the purpose of correcting the object position information PI by using the affinity matrix AM (i.e., for the purpose of performing the refining operation). Therefore, the feature map transformation unit 2131 of the object verification unit 213 is configured to generate the feature map CM that is more suitable for generating the affinity matrix AM. The feature map transformation unit 2141 of the refining unit 214 is configured to generate the feature map CM′ that is more suitable for correcting the object position information PI.

The feature map transformation unit 2141 may generate the feature map CM′ (e.g., at least one of the feature maps CM′_{t-τ} and CM′ₜ) by using an arithmetic model that outputs the feature map CM′ when the object position information PI (e.g., the object position information PI_{t-τ} and PIₜ) is inputted. An example of such an arithmetic model is an arithmetic model using a neural network (e.g., a CNN). A parameter of the arithmetic model may be optimized to output an appropriate feature map CM′ (in particular, the feature map CM′ suitable for correcting object position information PI).

In the flowchart in FIG. 8, after the step S202, the feature vector transformation unit 2142 may generate a feature vector CV′_{t-τ} from the feature map CM′_{t-τ} (step S203). The feature vector transformation unit 2142 may generate a feature vector CV′ₜ from the feature map CM′ₜ (step S203).

In the flowchart in FIG. 8, in parallel with, or before or after the steps S201 to S203, the matrix operation unit 2143 may acquire the affinity matrix AM generated by the object verification unit 213 (specifically, the feature transformation unit 2133) (step S204). The matrix operation unit 2143 may generate a feature vector CV_res by using the feature vector CV′ₜ and the affinity matrix AM (step S205). In the step S205, the matrix operation unit 2143 may generate, as the feature vector CV_res, information (i.e., matrix product) by arithmetic processing of calculating the matrix product of the feature vector CV′ₜ and the affinity matrix AM.

In the flowchart in FIG. 8, after the step S205, the feature vector transformation unit 2142 may generate a feature map CM_res from the feature vector CV_res (step S206). In the step S206, the feature vector transformation unit 2142 may generate the feature map CM_res by transforming the feature vector CV_res into the feature map CM_res.

In the flowchart in FIG. 8, after the step S206, the feature map transformation unit 2141 may generate object position information PI_{t_res} from the feature map CM_res (step S207). In the step S207, the feature map transformation unit 2141 may generate the object position information PI_{t_res} from the feature map CM_res, by transforming the dimensions of the feature map CM_res.

For example, the feature map transformation unit 2141 may generate the object position information PI_{t_res} by using an arithmetic model that outputs the object position information PI_{t_res} when the feature map CM_res is inputted. An example of such an arithmetic model is an arithmetic model using a neural network (e.g., CNN). A parameter of the arithmetic model may be optimized to output appropriate object position information PI_{t_res}.

The feature map transformation unit 2141 may generate, from the feature map CM_res, the object position information PI_{t_res} including (i) map information indicating the key point KP of the object Oₜ in the frame FR2, (ii) map information indicating the size of the bounding box BB of the object Oₜ in the frame FR2, and (iii) map information indicating the local offset of the bounding box BB of the object Oₜ in the frame FR2.

The processing in the step SS207 may be considered to be substantially equivalent to processing of generating the object position information PI_{t_res} by using an attention mechanism that uses the affinity matrix AM as a weight. That is, the refining unit 214 may constitute at least a part of the attention mechanism. The object position information PIₜ may be used as the refined object position information PIₜ. In this case, the processing in the step S207 may be considered to be substantially equivalent to processing of correcting (in other words, updating, adjusting, or improving) the object position information PIₜ by using the attention mechanism that uses the affinity matrix AM as a weight.

Here, there is a possibility that the object position information PI_{t_res} loses information having been included in the original object position information PIₜ (i.e., the object position information PIₜ that is not refined). This is because the affinity matrix AM, which indicates a part to which attention should be paid in the attention mechanism (in this case, a detection position of the object O), is used as a weight in the object position information PI_{t_res}. Therefore, there is a possibility of losing an information part that is different from the information about the detection position of the object O, of the object detection information.

The refining unit 214 may perform processing for reducing/preventing a loss of the information having been included in the original object position information PIₜ. Specifically, the residual processing unit 2144 may correct object position information PIₜ ref by adding the object position information PI_{t_res} to the original object position information PIₜ (step S208).

In the step S208, the residual processing unit 2144 may add the map information indicating the key point KP of the object Oₜ included in the object position information PI_{t_res}, and the map information indicating the key point KP of the object Oₜ included in the original object position information PIₜ. The residual processing unit 2144 may add the map information indicating the size of the bounding box BB of the object Oₜ included in the object position information PI_{t_res} and the map information indicating the size of the bounding box BB of the object Oₜ included in the original object position information PIₜ. The residual processing unit 2144 may add the map information indicating the local offset of the bounding box BB included in the object position information PI_{t_res} and the map information indicating the local offset of the bounding box BB included in the original object position information PIₜ.

The processing in the step S208 may be considered to be substantially equivalent to processing of generating the object position information PI_{t_ref} by using a residual attention mechanism including the residual processing unit 2144. That is, the refining unit 214 may constitute at least a part of the residual attention mechanism.

The object position information PI_{t_ref} includes the information having been included in the original object position information PIₜ. For example, when the object verification operation is performed to collate/verify the object Oₜ included in the frame FR2 with the object O_{t+τ} included in the frame FR3, the feature map transformation unit 2131 of the object verification unit 213 may acquire the object position information PI_{t_ref}, instead of the object position information PIₜ. That is, the feature map transformation unit 213 may generate the feature map CMₜ from the object position information PI_{t_ref}.

The refining unit 214 may not perform the processing for reducing/preventing the loss of the information having been included in the original object position information PIₜ (i.e., the processing in step S208). In this case, the refining unit 214 may not include the residual processing unit 2144. The refining unit 214 may calculate the loss of at least one of the object position information PI_{t_res} and PI_{t_ref}, based on a loss function relating to at least one of the object position information PI_{t_res} and PI_{t_ref}.

### (3) Associating Operation

An associating operation of associating the object O by using the affinity matrix AM generated by the object verification unit 213 (specifically, the feature transformation unit 2133) will be described. As an example, the following describes an associating operation between the object O_{t-τ} (i.e., the four objects O_{t-τ}#1, O_{t-τ}#2, O_{t-τ}#3, and O_{t-τ}#4) included in the frame FR1 and the object Oₜ (i.e., the four objects Oₜ#1, Oₜ#2, Oₜ#3, and Oₜ#4) included in the frame FR2.

In the affinity matrix AM illustrated in FIG. 6, let the value of the component a₁₁ be the largest among the components a₁₁, a₁₂, a₁₃ and a₁₄. Let the value of the component a₂₂ be the largest among the components a₂₁, a₂₂, a₂₃ and a₂₄. Let the value of the component a₃₃ be the largest among the components a₃₁, a₃₂, a₃₃ and a₃₄. Let the value of the component a₄₄ be the largest among the components a₄₁, a₄₂, a₄₃, and a₄₄.

The calculation unit 215 calculates an index indicating a likelihood that the object Oₜ included in the frame FR2 corresponds to the object O_{t-τ} included in the frame FR1. As mentioned above, since the affinity matrix AM is information indicating the correspondence relation between the object Oₜ and the object O_{t=τ}, each component of the affinity matrix AM may be considered to be a correspondence score between the object Oₜ and the object O_{t-τ}. Here, a class indicating “being associated” is a class pos, and a class that indicating “not being associated” is a class neg. The calculation unit 215 may classify the object Oₜ included in the frame FR2, into the class pos or the class neg, based on the affinity matrix AM.

The value of the component an is the largest among the components a₁₁, a₁₂, a₁₃, and a₁₄ of the affinity matrix AM. In this case, it is highly likely that the object Oₜ #1 included in the frame FR2 corresponds to the object O_{t-τ}#1 included in the frame FR1. In this case, the calculation unit 215 may calculate a probability that the object Oₜ#1 included in the frame FR2 is associated with the object O_{t-τ}#1 included in the frame FR1 (in other words, a probability that the object Oₜ#1 included in the frame FR2 belongs to the class pos). This calculation result may be expressed as “p(pos|Oₜ#1)”. For example, it may be “p(pos|Oₜ#1)=a₁₁”. The calculation unit 215 may calculate a probability that the object Oₜ#1 included in the frame FR2 is not associated with the object O_{t-τ}#1 included in the frame FR1 (in other words, a probability that the object Oₜ#1 included in the frame FR2 belongs to the class neg). This calculation result may be expressed as “p(neg|Oₜ#1)”. For example, it may be “p(neg|Oₜ#1)=1-a₁₁”.

The calculation unit 215 may calculate a likelihood ratio “p(pos|Oₜ#1)/p(neg|Oₜ#1)”, as an index indicating a likelihood that the object Oₜ#1 included in the frame FR2 corresponds to the object O_{t-τ}#1 included in the frame FR1. In addition, “p(pos|Oₜ#1)” may be referred to as first information indicating that the object Oₜ#1 included in the frame FR2 corresponds to the object O_{t-τ}#1 included in the frame FR1. In addition, “p(neg|Oₜ#1)” may be referred to as second piece information indicating that the object Oₜ#1 included in the frame FR2 does not correspond to the object O_{t-τ}#1 included in the frame FR1.

By the way, the calculation unit 215 may calculate the index indicating the likelihood that the object Oₜ included in the frame FR2 corresponds to the object O_{t-τ} included in the frame FR1 (e.g., “p(pos|Oₜ)/p(neg|Oₜ)”), by taking into account a connection between the object Oₜ included in the frame FR2 and the object O_{t-τ} included in the frame FR1. In this case, the above-mentioned index may be expressed as “p(pos|Oₜ, O_{t-τ})/p(neg|Oₜ, O_{t-τ})”. In the present example embodiment, however, it is possible to use the affinity matrix AM that is information indicating the correspondence relation between the object Oₜ and the object O_{t-τ} (in other words, the connection between the object Oₜ and the object O_{t-τ}). The use of the affinity matrix AM makes it possible to treat a pair of the objects Oₜ and O_{t-τ} as a single element. Therefore, according to the present example embodiment, it is possible to reduce a calculation cost for the calculation unit 215 to calculate the above-mentioned index.

As mentioned above, the value of the component a₂₂ is the largest among the components a₂₁, a₂₂, a₂₃, and a₂₄. In this case, it is highly likely that the object Oₜ#2 included in the frame FR2 corresponds to the object O_{t-τ}#2 included in the frame FR1. The calculation unit 215 may calculate a likelihood ratio “p(pos|Oₜ#2)/p(neg|Oₜ#2)”, as an index indicating a likelihood that the object Oₜ#2 included in the frame FR2 corresponds to the object O_{t-τ}#2 included in the frame FR1.

As mentioned above, the value of the component a₃₃ is the largest among the components a₃₁, a₃₂, a₃₃, and a₃₄. In this case, it is highly likely that the object Oₜ#3 included in the frame FR2 corresponds to the object O_{t-τ}#3 included in the frame FR1. The calculation unit 215 may calculate a likelihood ratio “p(pos|Oₜ#3)/p(neg|Oₜ#3)”, as an index indicating a likelihood that the object Oₜ#3 included in the frame FR2 corresponds to the object O_{t-τ}#3 included in the frame FR1.

As mentioned above, the value of the component a₄₄ is the largest among the components a₄₁, a₄₂, a₄₃, and a₄₄. In this case, it is highly likely that the object Oₜ#4 included in the frame FR2 corresponds to the object O_{t-τ}#4 included in the frame FR1. The calculation unit 215 may calculate a likelihood ratio “p(pos|Oₜ|#4)/p(neg|Oₜ#4)”, as an index indicating a likelihood that the object Oₜ#4 included in the frame FR2 corresponds to the object O_{t-τ}#4 included in the frame FR1.

The calculation unit 215 may calculate a logarithmic likelihood ratio (e.g., Log{p(pos|Oₜ)/p(neg|Oₜ)}), as the index indicating the likelihood that the object Oₜ included in the frame FR2 corresponds to the object O_{t-τ} included in the frame FR1. The above-mentioned index (e.g., the likelihood ratio, the logarithmic likelihood ratio) may also be referred to as a certainty factor.

The determination unit 216 determines whether or not the object Oₜ included in the frame FR2 corresponds to the object O_{t-τ} included in the frame FR1, based on the index (e.g., the likelihood ratio) calculated by the calculation unit 215. The determination unit 216 may determine whether or not the likelihood ratio “p(pos|Oₜ#1)/p(neg|Oₜ#1)” is greater than a threshold th1, for the object Oₜ#1 included in the frame FR2. When the likelihood ratio “p(pos|Oₜ#1)/p(neg|Oₜ#1)” is greater than the threshold th1, the determination unit 216 may determine that the object Oₜ#1 included in the frame FR2 is suitable as a reference for the association in the next frame. When the likelihood ratio “p(pos|Oₜ#1)/p(neg|Oₜ#1)” is less than the threshold th1, the determination unit 216 may determine that the object Oₜ#1 included in the frame FR2 is not suitable as the reference for the association in the next frame. When the likelihood ratio “p(pos|Oₜ#1)/p(neg|Oₜ#1)” is equal to the threshold th1, it may be treated as either case.

In a case where the indicator calculated by the calculation unit 215 is the logarithmic likelihood ratio, the threshold th1 may be “1”. This is because when the likelihood ratio exceeds 1, p(pos|Oₜ)>p(neg|Oₜ) and it is appropriate to be classified into the class pos indicating “being associated”.

The determination unit 216 may determine whether or not the likelihood ratio “p(pos|Oₜ#2)/p(neg|Oₜ#2)” is greater than the threshold th1, for the object Oₜ#2 included in the frame FR2. When the likelihood ratio “p(pos|Oₜ#2)/p(neg|Oₜ#2)” is greater than the threshold th1, the determination unit 216 may determine that the object Oₜ#2 included in the frame FR2 is suitable as the reference for the association in the next frame. When the likelihood ratio “p(pos|Oₜ#2)/p(neg|Oₜ#2)” is less than the threshold th1, the determination unit 216 may determine that the object Oₜ#2 included in the frame FR2 is not suitable as the reference for the association in the next frame. When the likelihood ratio “p(pos|Oₜ#2)/p(neg|Oₜ#2)” is equal to the threshold th1, it may be treated as either case.

The determination unit 216 may determine whether or not the likelihood ratio “p(pos|O₁#3)/p(neg|Oₜ#3)” is greater than the threshold th1, for the object Oₜ#3 included in the frame FR2. When the likelihood ratio “p(pos|Oₜ#3)/p(neg|Oₜ#3)” is greater than the threshold th1, the determination unit 216 may determine that the object Oₜ#3 included in the frame FR2 is suitable as the reference for the association in the next frame. When the likelihood ratio “p(pos|Oₜ#3)/p(neg|Oₜ#3)” is less than the threshold th1, the determination unit 216 may determine that the object Oₜ#3 included in the frame FR2 is not suitable as the reference for the association in the next frame. When the likelihood ratio “p(pos|Oₜ#3)/p(neg|Oₜ#3)” is equal to the threshold th1, it may be treated as either case.

The determination unit 216 may determine whether or not the likelihood ratio “p(pos|Oₜ#4)/p(neg|Oₜ#4)” is greater than the threshold th1, for the object Oₜ#4 included in the frame FR2. When the likelihood ratio “p(pos|Oₜ#4)/p(neg|Oₜ#4)” is greater than the threshold th1, the determination unit 216 may determine that the object Oₜ#4 included in the frame FR2 is suitable as the reference for the association in the next frame. When the likelihood ratio “p(pos|Oₜ#4)/p(neg|Oₜ#4)” is less than the threshold th1, the determination unit 216 may determine that the object Oₜ#4 included in the frame FR2 is not suitable as the reference for the association in the next frame. When the likelihood ratio “p(pos|Oₜ#4)/p(neg|Oₜ#4)” is equal to the threshold th1, it may be treated as either case.

The selection unit 217 associates the correspondence relation between the object Oₜ included in the frame FR2 with the object O_{t-τ} included in the frame FR1, based on a determination result of the determination unit 216 regarding the certainty factor in the log-likelihood ratio. The selection unit 217 may perform the association and the calculation of the certainty factor, for each Oₜ included in the frame FR2. The association may be performed by the determination unit 216, instead of the selection unit 217.

For example, when the determination unit 216 determines that the object Oₜ#1 included in the frame FR2 has a higher certainty factor than that of the object O_{t-τ}#1 included in the frame FR1 (e.g., the logarithmic likelihood ratio is higher than the threshold), the selection unit 217 may use the object Oₜ#1 included in the frame FR2 as the reference for the association in the next frame. Specifically, the selection unit 217 may assign the same tracking ID as the one assigned to the object O_{t-τ}#1 included in the frame FR1, to the object Oₜ#1 included in the frame FR2, and then use information necessary in the next frame for the object verification unit 213, as the feature CV_{t-τ}.

In this case, the selection unit 217 may select the object Oₜ#1 included in the frame FR2, as a criterion (e.g., a reference) for tracking the position in the frame FR3 of the object Oₜ#1 (see FIG. 3). As a result, the object tracking unit 211 may perform the object tracking operation on the object Oₜ#1 included in the frame FR2, by using the frames FR2 and FR3. In this case, the object verification unit 213 may use the object position information PI_{t_ref} or PI_{t_res} instead of the object position information PIₜ. The object position information PIₜ is information about the position of the object Oₜ in the frame FR2, which is obtained by the object detection unit 212 detecting the object Oₜ included in the frame FR2. The object position information PI_{t_ref} or PI_{t_res} is the refined object position information PIₜ generated by the refining unit 214.

On the other hand, when the determination unit 216 determines that the object Oₜ#1 included in the frame FR2 has a lower certainty factor than that of the object O_{t-τ}#1 included in the frame FR1 (e.g., the logarithmic likelihood ratio is lower than the threshold), the selection unit 217 may not associate the object Oₜ#1 included in the frame FR2 with the object O_{t-τ}#1 included in the frame FR1. In this case, the selection unit 217 may determine the object Oₜ#1 included in the frame FR2 to be a new object (i.e., a different object from the object O_{t-τ} included in the frame FR1). In this case, the selection unit 217 may assign a new tracking ID (in other words, an unused tracking ID) to the object Oₜ#1 included in the frame FR2.

In this case, the selection unit 217 may select the object O_{t-τ}#1 included in the frame FR1, as a criterion (e.g., a reference) for tracking the position in the frame FR3 of the object O_{t-τ}#1. This is because the frame FR2 does not include an object corresponding to the object O_{t-τ}#1 included in the frame FR1. As a result, the object tracking unit 211 may perform the object tracking operation on the object O_{t-τ}#1 included in the frame FR1, by using the frames FRI and FR3.

For example, when the determination unit 216 determines that the object Oₜ#1 included in the frame FR2 has a higher certainty factor than that of the object O_{t-τ}#1 included in the frame FR1, but the determination unit 216 determines that the object Oₜ#2 included in the frame FR2 has a lower certainty factor than that of the object O_{t-τ}#2 included in the frame FR1, the selection unit 217 may select the object Oₜ#1 included in the frame FR2 as a criterion (e.g., a reference) for tracking the position in the frame FR3 of the object Oₜ#1, and may select the object O_{t-τ}#2 included in the frame FRI as a criterion (e.g., a reference) for tracking the position in the frame FR3 of the object O_{t-τ}#2.

As a result, the object tracking unit 211 may perform the object tracking operation on the object Oₜ#1 included in the frame FR2, by using the frames FR2 and FR3. The object tracking unit 211 may perform the object tracking operation on the object O_{t-τ}#2 included in the frame FR1, by using the frames FR1 and FR3.

The above-mentioned operation of the information processing apparatus 2 may be realized by the information processing apparatus 2 reading a computer program recorded on a recording medium. In this case, it can be said that a computer program for causing the information processing apparatus 2 to perform the above-mentioned operation is recorded on the recording medium.

### (Technical Effect)

In a case where a plurality of images (e.g., video/moving images) captured by a camera as the time-series data are used to track an object included in the images, the following technical problems may occur. For example, due to the object to be tracked being hidden behind another object, a camera may be temporarily hard to capture images of this tracking target. In this case, due to the object in one image being not included in another image that is captured after the one image, the tracking of the object may be ended. For example, the object to be tracked may change irregularly. Specifically, in a case where the object is a person, the object may suddenly crouch down or change its moving direction. In this case, even if the same object is included in one image and another image that is captured after the one image, the object in the one image and the object in the other image may not be associated with each other. In this case, the object in the other image may be recognized as a new object.

As illustrated in FIG. 9, let us assume that a state of a person P serving as the object to be tracked changes. Specifically, at times t1 and t2, the person P is walking. At times t3 and t4, the person P is jumping up. At times t5 and t6, the person P is walking again. In this instance, in a case where the person P is tracked by using an image including the person P captured at the time t2 and an image including the person P captured at the time t3, there is a possibility that the person P included in the image captured at the time t2 is determined to not correspond to the person P in the image captured at the time t3. This is because there is a relatively large difference between the state (e.g. posture) of the person P captured at the time t2 and the state of the person P captured at the time t3. In this case, the person P captured at the time t2 and the person P captured at the time t3 may be treated as different persons. That is, the tracking of a tracking ID assigned to the person P captured at the time t2 may be ended, and a new tracking ID may be assigned the person P captured at the time t3.

In addition, in a case where the person P is tracked by using an image including the person P t captured at the time t4 and an image including the person P captured at the time t5, there is a possibility that the person P included in the image captured at the time t4 is determined to not correspond to the person P included in the image captured at the time t5. This is because there is a relatively large difference between the state (e.g. posture) of the person P captured at the time t4 and the state of the person P captured at the time t5. In this case, the person P captured at the time t4 and the person P captured at the time t5 may be treated as different persons. That is, the tracking of a tracking ID assigned to the person P captured at the time t4 may be ended, and a new tracking ID may be assigned to the person P captured at the time t5.

A possible solution to this technical problem is a method of object tracking (in other words, object association) by using three or more images. However, since three or more images need to be processed in a single object tracking operation, real-time processing is extremely difficult. Furthermore, in a case where the time-series data are a 30 FPS (frames per second) video, only object movements of about 0.1 seconds is taken into consideration, from the viewpoint of the calculation cost.

For example, the determination unit 216 may determine whether or not the object Oₜ included in the frame FR2 corresponds to the object O_{t-τ} included in the frame FR1. When it is determined that the object Oₜ included in the frame FR2 corresponds to the object O_{t-τ} included in the frame FR1, the selection unit 217 may select the object Oₜ included in the frame FR2, as a criterion (e.g., a reference) for tracking the position in the frame FR3 of the object O. As a result, the object tracking unit 211 may perform the object tracking operation on the object Oₜ included in the frame FR2, by using the frames FR2 and FR3. On the other hand, when it is determined that the object Oₜ included in the frame FR2 does not correspond to the object O_{t-τ} included in the frame FR1, the selection unit 217 may select the object O_{t-τ} included in the frame FR1, as a criterion (e.g., a reference) for tracking the position in the frame FR3 of the object O. As a result, the object tracking unit 211 may perform the object tracking operation on the object O_{t-τ} included in the frame FR1, by using the frames FR1 and FR3.

In the example illustrated in FIG. 9, the determination unit 216 may determine that the person P included in the image captured at the time t2 does not correspond to the person P included in the image captured at the time t3. In this case, the selection unit 217 may select the person P included in the image captured at the time t2, as a criterion (e.g., a reference) for tracking the position of the person P in the image captured at the time t4.

The object tracking unit 211 may perform the object tracking operation by using the image captured at the time t2 and the image captured at the time t4. The determination unit 216 may determine that the person P included in the image captured at the time t2 does not correspond to the person P included in the image captured at the time t4. In this case, the selection unit 217 may select the person P included in the image captured at the time t2, as a criterion (e.g., a reference) for tracking the position of the person P in the image captured at the time t5.

The object tracking unit 211 may perform the object tracking operation by using the image captured at the time t2 and the image captured at the time t5. The determination unit 216 may determine that the person P included in the image captured at the time t2 corresponds to the person P included in the image captured at the time t5. In this case, the selection unit 217 may assign the same tracking ID as the one assigned to the person P included in the image captured at the time t2, to the person P included in the image captured at the time t5.

According to the information processing apparatus 2, even if it is temporarily hard to capture images of the object to be tracked, or even if the object to be tracked changes irregularly, it is possible to properly track the object to be tracked. In addition, since the object tracking operation performed by the object tracking unit 211 is performed by using two images, it is possible to reduce the calculation cost and to perform real-time processing.

The object to be tracked is not limited to a person (e.g., a person P). The object to be tracked may be a moving object such as a vehicle. The information processing apparatus 2 may be realized by a server apparatus (e.g., a cloud server) or by a terminal apparatus (e.g., at least one of a smartphone, a tablet terminal, and a notebook-type personal computer).

### (Modification)

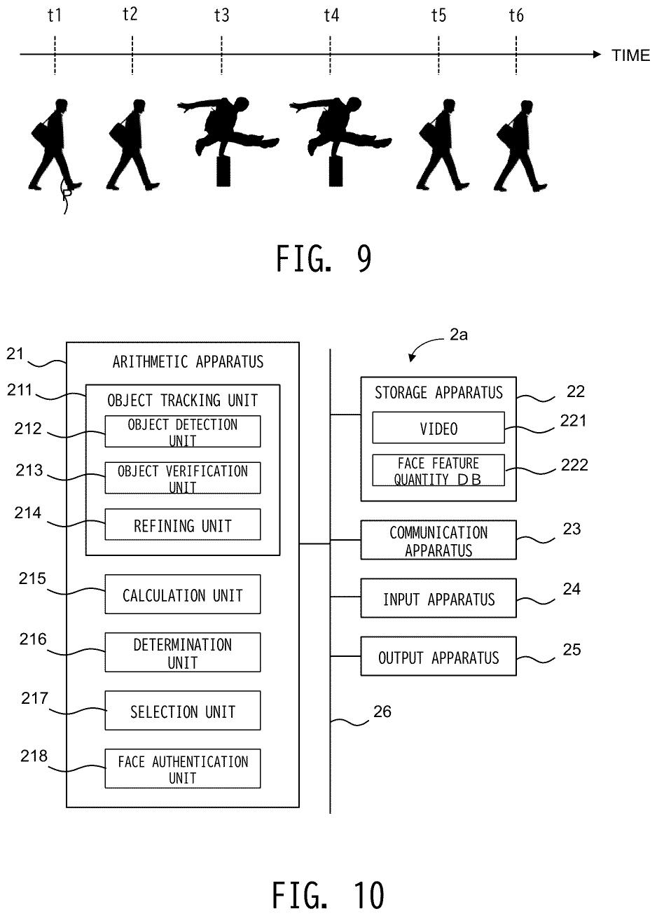

In a case where the object to be tracked is a person (e.g., a person P), not only the object tracking operation, but also a face authentication operation may be performed. In FIG. 10, an information processing apparatus 2a may include a face authentication unit 218 in order to perform the face authentication operation. The storage apparatus 22 may include a face feature quantity database 222 (hereinafter referred to as a “face feature quantity DB 222”). Furthermore, an existing technology/technique (e.g., at least one of a two-dimensional (2D) authentication method and a three-dimensional (3D) authentication method) is applicable to the face authentication operation.

The face authentication unit 218 may detect a face of the object O (here, a person) included in the frame (e.g., at least one of the frames FR1 and FR2), based on the object position information PI (e.g., at least one of the object position information PI_{t-τ} and PIₜ) acquired by the object detection unit 212. Since the existing technology/technique is applicable to a method of detecting the face of the person from the frame (image), the details of the method will be omitted.

When the face is detected, the face authentication unit 218 may generate a face image including a face area in the frame. The face authentication unit 218 may extract a feature quantity from the generated face image. The face authentication unit 218 may calculate a matching score (or a similarity score), based on the extracted feature quantity and feature quantities registered in the face feature quantity DB 222. The face authentication unit 218 may compare the calculated matching score with a threshold th2. When the matching score is greater than the threshold th2, the face authentication unit 218 may determine that face authentication is successful. In this case, the face authentication unit 218 may associate the object O (here, a person) included in the frame with an authentication ID registered in the face feature quantity DB 222.

When the matching score is less than the threshold th2, the face authentication unit 218 may determine that the face authentication is failed. When the matching score is equal to the threshold th2, it may be treated as either case. When the face is not detected from a certain frame, the face authentication unit 218 may not perform the face authentication operation for that frame.

### Third Example Embodiment

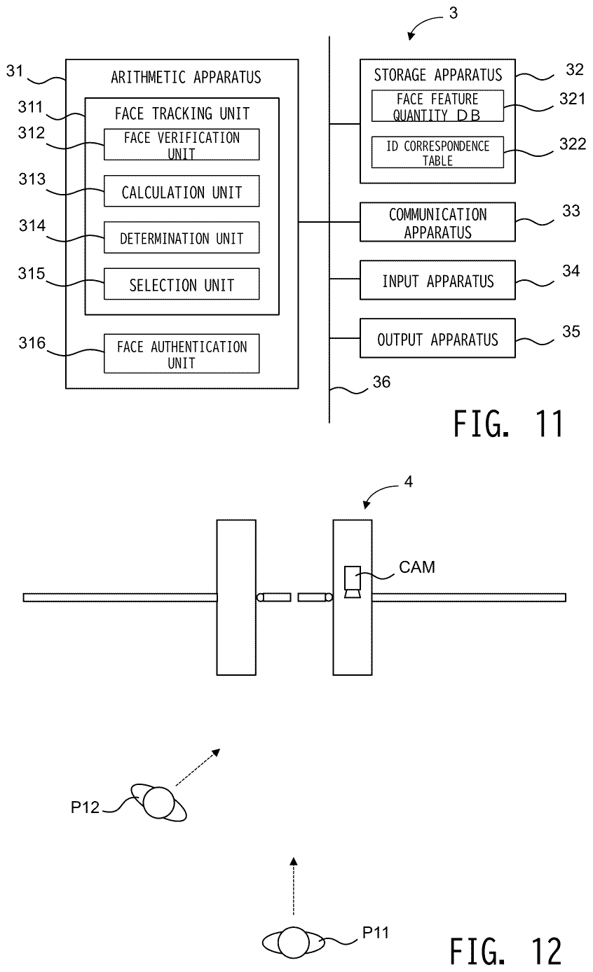

An information processing apparatus, an information processing method, and a recording medium according to a third example embodiment will be described with reference to FIG. 11 and FIG. 12. The following describes the information processing apparatus, the information processing method, and the recording medium according to the third example embodiment, by using an information processing apparatus 3.

As illustrated in FIG. 11, the information processing apparatus 3 includes an arithmetic apparatus 31, a storage apparatus 32, and a communication apparatus 33. The information processing apparatus 3 may include an input apparatus 34 and an output apparatus 35. The information processing apparatus 3 may not include at least one of the input apparatus 34 and the output apparatus 35. In the information processing apparatus 3, the arithmetic apparatus 31, the storage apparatus 32, the communication apparatus 33, the input apparatus 34, and the output apparatus 35 may be connected via a data bus 36. The storage apparatus 32 may include a face feature quantity database 321 (hereinafter referred to as a “face feature quantity DB 321”) and an ID correspondence table 322.

A basic configuration of each of the arithmetic apparatus 31, the storage apparatus 32, the communication apparatus 33, the input apparatus 34, and the output apparatus 35 may be the same as that of respective one of the arithmetic apparatus 21, the storage apparatus 22, the communication apparatus 23, the input apparatus 24, and the output apparatus 25 in the second example embodiment described above. Therefore, an description of the basic configuration of each of the arithmetic apparatus 31, the storage apparatus 32, the communication apparatus 33, the input apparatus 34, and the output apparatus 35 will be omitted.

The arithmetic apparatus 31 may include a face tracking unit 311 and a face authentication unit 316, as functional blocks that are logically realized, or as processing circuits that are physically realized. At least one of the face tracking unit 311 and the face authentication unit 316 may be realized in mixed forms of the logical functional blocks and the physical processing circuits (i.e., hardware). When at least a part of the face tracking unit 311 and the face authentication unit 316 is the functional block, at least the part of the face tracking unit 311 and the face authentication unit 316 may be realized by the arithmetic apparatus 31 executing a predetermined computer program.

The arithmetic apparatus 31 may acquire (in other words, may read) the predetermined computer program, from the storage apparatus 32. The arithmetic apparatus 31 may read the predetermined computer program stored on a computer-readable and non-transitory recording medium, by using a not-illustrated recording medium reading apparatus provided in the information processing apparatus 3. The arithmetic apparatus 31 may acquire (in other words, may downloaded or may read) the predetermined computer program from a not-illustrated apparatus disposed outside the information processing apparatus 3 via the communication apparatus 33. For the recording medium on which the predetermined computer program to be executed by the arithmetic apparatus 31 is recorded, at least one of an optical disk, a magnetic medium, a magneto-optical disk, a semiconductor memory, and any other medium that is configured to store a program may be used.

Let us assume that the information processing apparatus 3 constitutes a part of a face authentication gate apparatus 4 illustrated in FIG. 12. The information processing apparatus 3 may be a different apparatus from the face authentication gate apparatus 4. In this case, the information processing apparatus 3 may be configured to communicate with the face authentication gate apparatus 4 via the communication apparatus 33. In this case, the information processing apparatus 3 may be realized by a server apparatus (e.g., a cloud server) or by a terminal apparatus (e.g., at least one of a smartphone, a tablet terminal, and a notebook-type personal computer).

The face authentication gate apparatus 4 includes a camera CAM. The face authentication unit 316 of the information processing apparatus 3 may perform the face authentication operation by using a face image generated by the camera CAM capturing a face of an authentication subject (e.g., a person intending to pass through the face authentication gate apparatus 4). When the face authentication of the authentication subject is successful, the face authentication gate apparatus 4 permits the authentication subject to pass through. In a case where the face authentication gate apparatus 4 is a flap-type gate apparatus, the face authentication gate apparatus 4 may open a flap. On the other hand, when the face authentication of the authentication subject is failed, the face authentication gate apparatus 4 does not permit the authentication subject to pass through. In this case, the face authentication gate apparatus 4 may close the flap. The face authentication gate apparatus 4 may not be limited to the flap-type gate apparatus, but may also be an arm-type gate apparatus or a slide-type gate apparatus.

The camera CAM captures the face of the authentication subject, who are approaching the face authentication gate apparatus 4, a plurality of times. As a result, a plurality of face images that are temporally continuous may be generated. These plurality of face images correspond to another example of “the time-series data” in the first example embodiment described above. The face authentication unit 316 may perform the face authentication operation by using at least one of the plurality of face images. Thus, when the face authentication is successful, the face authentication gate apparatus 4 is allowed to open the flap before the authentication subject arrives at the face authentication gate apparatus 4. As a result, the authentication subject can pass through the face authentication gate apparatus 4 without stopping at the face authentication gate apparatus 4. That is, the face authentication gate apparatus 4 is a so-called walk-through type face authentication gate apparatus.

In FIG. 12, when the face authentication unit 316 performs the face authentication operation by using the face images generated by the camera CAM capturing the face of a person P11 (i.e., an authentication subject), a person P12 may cut in front of the person P11. In this instance, in a case where the flap of the face authentication gate apparatus 4 is open due to a success in the face authentication of the person P11, there is a possibility that the person P12 passes through the face authentication gate apparatus 4. In FIG. 12, dotted arrows indicate moving directions of the persons P11 and P12.

The face tracking unit 311 of the arithmetic apparatus 31 may perform a face tracking operation by using the plurality of face images generated by the camera CAM capturing the authentication subject (e.g., at least one of the persons P11 and P12) a plurality of times. For example, let us assume that a face F_{t-τ} included in a face image captured at the time t−τ is a face of the person P11. A unique tracking ID is assigned to the face of the person P11 serving as the face F_{t-τ}. The tracking ID assigned to the face of the person P11 is assumed to be “00001”.

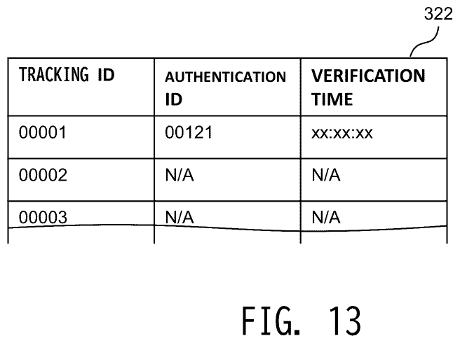

The tracking ID is registered in the ID mapping table 322. As illustrated in FIG. 13, the ID correspondence table 322 indicates a correspondence relation between the tracking ID and an authentication ID. The ID correspondence table 322 may include a verification time that is a time at which the face authentication operation is performed.

The face authentication unit 316 may perform the face authentication operation by using the face image including the face to which the tracking ID is assigned. The face authentication unit 316 may extract a feature quantity of the face image including the face to which the tracking ID is assigned. The face authentication unit 316 may calculate a matching score (or similarity score), based on the extracted feature quantity and feature quantities registered in the face feature quantity DB 321. The face authentication unit 316 may compare the calculated matching score with a threshold th3.

When the matching score is greater than the threshold th3, the face authentication unit 316 may determine that the face authentication is successful. In this case, the face authentication unit 316 may associate the tracking ID (in other words, the face included in the face image) with an authentication ID registered in the face feature quantity DB 321. The face authentication unit 316 may associate the tracking ID with the authentication ID by registering the authentication ID in the ID mapping table 322.

When the matching score is less than the threshold th3, the face authentication unit 316 may determine that the face authentication is failed. In this case, the face authentication unit 316 may register information indicating that there is no applicable person (e.g., “N/A (Not Applicable)”) in the ID correspondence table 322. Wehn the matching score is “equal” to the threshold th3, it may be treated as either case.

Here, let us assume that the face authentication is successful for the person P11, and that an authentication ID “00121” is assigned to a tracking ID “00001”.

The face tracking unit 311 includes a face verification unit 312, a calculation unit 313, a determination unit 314, and a selection unit 315. The face verification unit 312 may extract a feature quantity of a face image captured at the time t−τ (here, a face image including the face of the person P11), and may extract a feature quantity of a face image captured at the time t. The face verification unit 312 may calculate the matching score, based on the feature quantity of the face image captured at the time t−τ and the feature quantity of the face image captured at the time t. A method of calculating the matching score may use the method of calculating the matching score in the face authentication operation. The operation of the face verification unit 312 may be performed by the face authentication unit 316. In this case, the face tracking unit 311 may not include the face verification unit 312.

The calculation unit 313 may calculate an index indicating a likelihood that a face Fₜ included in a face image captured at the time t corresponds to the face F_{t-τ} included in the face image captured at the time t−τ, based on the matching score calculated by the face verification unit 312. The index may be a likelihood ratio or a logarithmic likelihood ratio. The determination unit 314 may compare the index calculated by the calculation unit 313 with a threshold th4.

When it is determined that the calculated index is greater than the threshold th4, the determination unit 314 may determine that the face Fₜ included in the face image captured at the time t corresponds to the face F_{t-τ} included in the face image captured at the time t−τ (here, the face of the person P11). In this case, the selection unit 315 may assign the same tracking ID as the one assigned to the face F_{t-τ} included in the face image captured at the time t−τ, to the face Ft included in the face image captured at the time t. In this case, the selection unit 315 may select the face image captured at the time t, as a criterion for tracking the face of the person P11.

When it is determined that the calculated index is less than the threshold th4, the determination unit 314 may determine that the face Ft included in the face image captured at the time t does not correspond to the face F_{t-τ} included in the face image captured at the time t−τ (here, the face of the person P11). In this case, the selection unit 314 may assign a different tracking ID (e.g., an unused tracking ID) from the one assigned to the face Ft included in the face image captured at the time t, to the face F_{t-τ} included in the face image captured at the time t−τ. In this case, the selection unit 314 may select the face image captured at the time t−τ, as a criterion for tracking the face of the person P11.

The face authentication gate apparatus 4 may determine whether or not to permit the authentication subject to pass through, based on the ID correspondence table 322 and the tracking ID assigned to the face included in the face image generated by the camera CAM capturing the authentication subject (e.g., at least one of the persons P11 and P12).

For example, in a case where the tracking ID assigned to the face included in the most recently generated face image is “00001” (i.e., in a case where the authentication subject is the person P11), this tracking ID is associated with the authentication ID “00121”. In this case, the face authentication gate apparatus 4 may permit the authentication subject (i.e., the person P11) to pass through. As a result, the face authentication gate apparatus 4 may open the flap.

For example, in a case where the tracking ID assigned to the face in the most recently generated face image is “00002” (e.g., in a case where the authentication subject is the person P12), this tracking ID is associated with “N/A”. In this case, the face authentication gate apparatus 4 may not permit the authentication subject (e.g., the person P12) to pass through. As a result, the face authentication gate apparatus 4 may close the flap.

### (Technical Effect)

The face authentication gate apparatus 4 may determine whether or not to permit the authentication subject to pass through, based on the ID correspondence table 322 and the tracking ID assigned to the face included in the most recent face image. For example, the tracking ID assigned to the face of the person P11 is different from the tracking ID assigned to the face of the person P12. Therefore, in a case where the person P12 cuts in front of the person P11, if the face authentication is not successful for the person P12 even though the face authentication is successful for the person P11, then, the flap of the face authentication gate apparatus 4 is closed. As a result, it is possible to prevent the person P12 from passing through the face authentication gate apparatus 4, before the end of the face authentication operation for the person P12 who cuts in front of the person P11.

For example, let us assume that the face image captured at the time t−τ includes the face of the person P11. Let us assume that the face image captured at the time t does not include the face of the person P11, but includes the face of the person P12. Let us assume that the face image captured at the time t+t does not include the face of the person P12, but includes the face of the person P11.

In this case, the determination unit 314 may determine that the face included in the face image captured at the time t (i.e., the face of the person P12) does not correspond to the face included in the face image captured at the time t−τ (i.e., the face of the person P11). In this case, the selection unit 314 may select the face image captured at the time t−τ, as a criterion for tracking the face of the person P11. As a result, the face tracking operation may be performed by using the face image captured at the time t−τ and the face image captured at the time t+τ. In this case, the determination unit 314 may determine that the face included in the face image captured at the time t+τ (i.e., the face of the person P11) corresponds to the face included in the face image captured at the time t−τ (i.e., the face of the person P11). In this case, the selection unit 315 may assign the same tracking ID as the one assigned to the face included in the face image captured at the time t−τ, to the face included in the face image captured at the time t+τ.

In this way, even when the camera CAM is temporarily hard to capture images of the face of the person P11 (i.e., the authentication subject), it is possible to properly track the face of the person P11. For example, in a case where the face authentication is successful for the person P11 before the camera CAM becomes incapable of capturing images of the face of the person P11, when the camera CAM becomes capable of capturing images of the face of the person P11, the person P11 may be permitted to pass through the face authentication gate apparatus 4, without the face authentication operation performed again on the person P11.

### Supplementary Notes

With respect to the example embodiment described above, the following Supplementary Notes are further disclosed.

### (Supplementary Note 1)

An information processing apparatus including:
a determination unit that determines whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data; and
a selection unit that selects the second element as a new criterion for the correspondence between the two elements when it is determined that the certainty factor is higher than the predetermined threshold, and that selects the first element as the criterion for the correspondence between the two elements when it is determined that the certainty factor is lower than the predetermined threshold.

### (Supplementary Note 2)

The information processing apparatus according to Supplementary Note 1, wherein
the time-series data is a video including a plurality of images,
the first element is an object in a first image captured at the first time, among the plurality of images,
the second element is an object in a second image captured at the second time, among the plurality of images,
the determination unit determines whether or not the certainty factor is higher than the predetermined threshold, in a case of obtaining a correspondence between the object in the second image and the object in the first image, by using the object in the first image as a criterion, and
the selection unit selects the object in the second image as a new criterion when it is determined that the certainty factor is higher than the predetermined threshold, and selects the object in the first image as a criterion when it is determined that the certainty factor is lower than the predetermined threshold.

### (Supplementary Note 3)

The information processing apparatus according to Supplementary Note 2, wherein
the information processing apparatus includes a tracking unit that tracks objects in the plurality of images, and
the tracking unit:
tracks the object in the first image by using the first image and a third image, which is captured at a third time after the second time among the plurality of images when the object in the first image is selected as the criterion by the selection unit; and
tracks the object in the second image by using the second image and the third image when the object in the second image is selected as the new criterion by the selection unit.

### (Supplementary Note 4)

The information processing apparatus according to Supplementary Note 2 or 3, wherein the information processing apparatus includes:
a first generation unit that generates a first feature vector indicating a feature quantity of first position information about a position of the object in the first image, and a second feature vector indicating a feature quantity of second position information about a position of the object in the second image, based on the first position information and the second position information;
a second generation unit that generates information obtained by arithmetic processing using the first feature vector and the second feature vector, as correspondence information indicating the correspondence relation between the object in the first image and the object in the second image; and
a calculation unit that calculates the certainty factor in the case of obtaining the correspondence between the object in the second image and the object in the first image, based on the correspondence information.

### (Supplementary Note 5)

The information processing apparatus according to Supplementary Note 4, wherein
the correspondence information includes first information indicating that the object in the second image corresponds to the object in the first image, and second information indicating that the object in the second image does not correspond to the object in the first image, and
the calculation unit calculates the certainty factor, based on the first information and the second information.

### (Supplementary Note 6)

The information processing apparatus according to Supplementary Note 5, wherein
the calculation unit calculates, as the certainty factor, a likelihood ratio that is a ratio of a probability serving as the first information that the object in the second image corresponds to the object in the first image, and a probability serving as the second information that the object in the second image does not correspond to the object in the first image.

### (Supplementary Note 7)

The information processing apparatus according to any one of Supplementary Notes 4 to 6, wherein the information processing apparatus includes a correction unit that corrects the second position information by using the correspondence information.

### (Supplementary Note 8)

The information processing apparatus according to Supplementary Note 7, wherein the correction unit corrects the second position information by using an attention mechanism that uses the correspondence information as a weight.

### (Supplementary Note 9)

The information processing apparatus according to Supplementary Note 7 or 8, wherein the first generation unit generates a corrected second feature vector indicating a feature quantity of the corrected second position information, based on the second position information corrected by the correction unit when the object in the second image is selected as the new reference by the selection unit.

### (Supplementary Note 10)

An information processing method including:
determining whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data;
selecting the second element as a new criterion for the correspondence between the two elements when it is determined that the certainty factor is higher than the predetermined threshold; and
selecting the first element as the criterion for the correspondence between the two elements when it is determined that the certainty factor is lower than the predetermined threshold.

### (Supplementary Note 11)

A recording medium on which a computer program that allows a computer to execute an information processing method is recorded, the information processing method including:
determining whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data;
selecting the second element as a new criterion for the correspondence between the two elements when it is determined that the certainty factor is higher than the predetermined threshold; and
selecting the first element as the criterion for the correspondence between the two elements when it is determined that the certainty factor is lower than the predetermined threshold.

The present disclosure is not limited to the example embodiments described above, but is allowed to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

1, 2, 2a, 3 Information processing apparatus
11, 216, 314 Determination unit
12, 217, 315 Selection unit
21, 31 Arithmetic apparatus
211 Object tracking unit
212 Object detection unit
214 Refining unit
215, 313 Calculation unit
218, 316 Face authentication unit
311 Face tracking unit
312 Face verification unit

What is claimed is:

1. 1. An information processing apparatus comprising:
at least one memory that is configured to store instructions; and
at least one processor that is configured to execute the instructions to:
determine whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data;
select the second element as a new criterion for the correspondence between the two elements when it is determined that the certainty factor is higher than the predetermined threshold; and
select the first element as the criterion for the correspondence between the two elements when it is determined that the certainty factor is lower than the predetermined threshold.

2. The information processing apparatus according to claim 1, wherein
the time-series data is a video including a plurality of images,
the first element is an object in a first image captured at the first time, among the plurality of images,
the second element is an object in a second image captured at the second time, among the plurality of images,
the at least one processor is configured to execute the instructions to:
determine whether or not the certainty factor is higher than the predetermined threshold, in a case of obtaining a correspondence between the object in the second image and the object in the first image, by using the object in the first image as a criterion;
select the object in the second image as a new criterion when it is determined that the certainty factor is higher than the predetermined threshold; and
select the object in the first image as a criterion when it is determined that the certainty factor is lower than the predetermined threshold.

3. The information processing apparatus according to claim 2, wherein
the at least one processor is configured to execute the instructions to:
track objects in the plurality of images;
track the object in the first image by using the first image and a third image, which is captured at a third time after the second time among the plurality of images, when the object in the first image is selected as the criterion; and
track the object in the second image by using the second image and the third image when the object in the second image is selected as the new criterion.

4. The information processing apparatus according to claim 2, wherein the information processing apparatus comprises:
the at least one processor is configured to execute the instructions to:
generate a first feature vector indicating a feature quantity of first position information about a position of the object in the first image, and a second feature vector indicating a feature quantity of second position information about a position of the object in the second image, based on the first position information and the second position information;
generate information obtained by arithmetic processing using the first feature vector and the second feature vector, as correspondence information indicating the correspondence relation between the object in the first image and the object in the second image; and
calculate the certainty factor in the case of obtaining the correspondence between the object in the second image and the object in the first image, based on the correspondence information.

5. The information processing apparatus according to claim 4, wherein
the correspondence information includes first information indicating that the object in the second image corresponds to the object in the first image, and second information indicating that the object in the second image does not correspond to the object in the first image, and
the at least one processor is configured to execute the instructions to calculate the certainty factor, based on the first information and the second information.

6. The information processing apparatus according to claim 5, wherein
the at least one processor is configured to execute the instructions to calculate, as the certainty factor, a likelihood ratio that is a ratio of a probability serving as the first information that the object in the second image corresponds to the object in the first image, and a probability serving as the second information that the object in the second image does not correspond to the object in the first image.

7. The information processing apparatus according to claim 4, wherein the at least one processor is configured to execute the instructions to correct the second position information by using the correspondence information.

8. The information processing apparatus according to claim 7, wherein the at least one processor is configured to execute the instructions to correct the second position information by using an attention mechanism that uses the correspondence information as a weight.

9. The information processing apparatus according to claim 7, wherein the at least one processor is configured to execute the instructions to generate a corrected second feature vector indicating a feature quantity of the corrected second position information, based on the second position information corrected when the object in the second image is selected as the new reference.

10. An information processing method comprising:
determining whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data;
selecting the second element as a new criterion for the correspondence between the two elements when it is determined that the certainty factor is higher than the predetermined threshold; and
selecting the first element as the criterion for the correspondence between the two elements when it is determined that the certainty factor is lower than the predetermined threshold.

11. A non-transitory recording medium on which a computer program that allows a computer to execute an information processing method is recorded, the information processing method including:
determining whether or not a certainty factor is higher than a predetermined threshold, in a case of obtaining a correspondence between a first element acquired at a first time and a second element acquired at a second time after the first time, by using the first element as a criterion for a correspondence between two elements, and the first and second elements being included in time-series data;
selecting the second element as a new criterion for the correspondence between the two elements when it is determined that the certainty factor is higher than the predetermined threshold; and
selecting the first element as the criterion for the correspondence between the two elements when it is determined that the certainty factor is lower than the predetermined threshold.
